(19) United States
(12) Patent Application Publication
(10) Pub. No.: US 2022/0082300 A1
(43) Pub. Date: Mar. 17, 2022

(54) TANKLESS WATER HEATER SYSTEMS AND METHODS THERETO

(71) Applicant: Rheem Manufacturing Company, Atlanta, GA (US)

(72) Inventors: Tristin R. Watteau, Auburn, AL (US); Govinda Mahajan, Pike Road, AL (US)

(21) Appl. No.: 17/023,818

(22) Filed: Sep. 17, 2020

(51) Int. Cl. F24H 9/20; F24D 17/00; F24H 1/10; G05D 23/19

(52) U.S. Cl. CPC F24H 9/2007; F24D 17/0036; G05D 23/1917; F24H 1/107; F24H 1/101

(57) ABSTRACT

The disclosed technology includes systems and methods for operating a fluid heating device comprising an electric heating element and a gas burner. The disclosed technology can include a system and method that can receive flow data from a flow sensor that is indicative of a flow rate of a fluid in a fluid heating system, determine if the flow rate is less than or equal to a threshold flow rate, and output a control signal to heat the fluid with the electric heating element, the gas burner, or both based on the flow rate data.

### FIELD OF TECHNOLOGY

The present disclosure relates generally to systems and methods for heating water with a tankless water heater, and, more specifically, to systems and methods for heating water with a tankless water heater having an electric heating element and a gas burner.

### BACKGROUND

Tankless water heaters, otherwise referred to as on-demand water heaters, are commonly used in residential and commercial applications to heat water. Generally, tankless water heaters use electric heating elements or gas burners to heat the water. When the water heating system is expected to heat water flowing at a relatively large flow rate, gas-burning tankless water heaters are often used. On the other hand, when a water heating system is expected to heat water flowing at a comparatively lower flow rate, electric tankless water heaters are often used. This is because it can be difficult to modulate a gas burner at a low enough firing rate to maintain a water temperature within a suitable temperature band during low flow conditions and gas-burning tankless water heaters tend to be inefficient when heating water at low flow rates. On the other hand, electric heating elements can be accurately controlled at low outputs to heat water flowing at low flow rates but require an electrical supply greater than the standard 120V power supply available in most homes to adequately heat water flowing at comparatively higher flow rates.

Because gas burners are capable of heating water flowing at a comparatively high flow rate, tankless water heaters having gas burners are often used to supply heated water to an entire house while tankless water heaters having electric heating elements are often used to supply heated water to a point of use such as a single sink or shower. Unfortunately, installing electric tankless water heaters at each point of use can be prohibitively expensive, and the expense required for installation can become even larger when an adequate power supply is not already available, requiring an electrician to route a new electricity line to the point of use.

These and other problems are addressed by the technology disclosed herein.

### SUMMARY

The disclosed technology relates generally to systems and methods for heating water with a tankless water heater, and, more specifically, to systems and methods for heating water with a tankless water heater having an electric heating element and a gas burner.

The disclosed technology can include, a non-transitory computer-readable medium that can have instructions stored on it that, when executed by one or more processors, cause a system to receive, from a flow sensor, flow data indicative of a flow rate of water in a tankless water heater system. The system can compare, based at least in part on the flow data, the flow rate to a first threshold flow rate and the flow rate to a second threshold flow rate. In response to determining that the flow rate is less than or equal to the first threshold flow rate, the system can output a control signal to heat the water with an electric heating element only. In response to determining that the flow rate is greater than the second threshold flow rate, the system can output a control signal to heat the water with a gas burner only.

The second threshold flow rate can be equal to the first threshold flow rate. Alternatively, the second threshold flow rate can be greater than the first threshold flow rate. If the second threshold flow rate is greater than the first threshold flow rate, the instructions, when executed by the one or more processors, can further cause the system to output a control signal to heat the water with both the electric heating element and the gas burner in response to determining that the flow rate is greater than the first threshold flow rate and less than or equal to the second threshold flow rate.

The non-transitory, computer-readable medium can also have instructions that cause the system to compare, based at least in part on the flow data, the flow rate to a third threshold flow rate that is greater than the second threshold flow rate. In response to determining that the flow rate is greater than the third threshold flow rate, the system can output a booster-mode control signal to heat the water with both the electric heating element and the gas burner. The first threshold flow rate can be about 1 gallon per minute or about 1.2 gallons per minute. Alternatively, the first threshold flow rate can be about 1 gallon per minute and the second threshold flow rate can be about 1.2 gallons per minute. The third threshold flow rate can be about 3 gallons per minute.

The instructions, when executed by the one or more processors, can further cause the system to receive, from a temperature sensor, temperature data indicative of a temperature of the water in the tankless water heater system. The system can compare, based at least in part on the temperature data, the temperature to a threshold temperature and, responsive to determining that the temperature is greater than the threshold temperature and the flow rate is less than the first threshold flow rate, the system can output a control signal to heat the water with the electric heating element only.

The instructions, when executed by the one or more processors, can further cause the system to output a control signal to heat the water with both the electric heating element and the gas burner in response to determining that the temperature is less than or equal to the threshold temperature and the flow rate is less than the first threshold flow rate.

The disclosed technology can include a fluid heating device comprising a fluid inlet, a fluid outlet, and a heating chamber. The heating chamber can be in fluid communication with the fluid inlet and the fluid outlet and configured to hold a fluid with a low fluid capacity. The system can also include a flow sensor configured to detect a flow of the fluid in the fluid heating device and output flow data indicative of a flow rate of the fluid, an electric heating element configured to heat the fluid, a gas burner configured to heat the fluid, and a controller. The controller can be configured to receive the flow data from the flow sensor and compare, based at least in part on the flow data, the flow rate to a first threshold flow rate and the flow rate to a second threshold flow rate. In response to determining that the flow rate is less than or equal to the first threshold flow rate, the controller can output a control signal to heat the fluid with an electric heating element only. In response to determining that the flow rate is greater than the second threshold flow rate, the controller can output a control signal to heat the fluid with a gas burner only.

The second threshold flow rate can be equal to the first threshold flow rate. The first threshold flow rate can be about 1 gallon per minute or about 1.2 gallons per minute. Alternatively, the second threshold flow rate can greater than the first threshold flow rate and the controller can be further configured to output a control signal to heat the fluid with both the electric heating element and the gas burner in response to determining that the flow rate is greater than the first threshold flow rate and less than or equal to the second threshold flow rate. The first threshold flow rate can be about 1 gallon per minute and the second threshold flow rate can be about 1.2 gallons per minute.

The controller can be further configured to compare, based at least in part on the flow data, the flow rate to a third threshold flow rate that is greater than the second threshold flow rate. In response to determining that the flow rate is greater than the third threshold flow rate, output a booster-mode control signal to heat the fluid with both the electric heating element and the gas burner. The third threshold flow rate can be about 3 gallons per minute.

The fluid heating device can further include a temperature sensor configured to detect a temperature of the fluid in the fluid heating device and output temperature data indicative of the temperature of the fluid. The controller can be configured to receive the temperature data from the temperature sensor and compare, based at least in part on the temperature data, the temperature to a threshold temperature. In response to determining that the temperature is greater than the threshold temperature and the flow rate is less than the first threshold flow rate, the controller can output a control signal to heat the fluid with the electric heating element only. In response to determining that the temperature is less than or equal to the threshold temperature and the flow rate is less than the first threshold flow rate, the controller can be further configured to output a control signal to heat the fluid with both the electric heating element and the gas burner.

Additional features, functionalities, and applications of the disclosed technology are discussed herein in more detail.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner.

FIG. 1 illustrates an example tankless water heater system, in accordance with the disclosed technology.

FIG. 2 is a flowchart illustrating an example method of heating water using an electric heating element and a gas burner, in accordance with the disclosed technology.

FIG. 3 is a flowchart illustrating another example method of heating water using an electric heating element and a gas burner, in accordance with the disclosed technology.

FIG. 4 is a flowchart illustrating yet another example method of heating water using an electric heating element and a gas burner, in accordance with the disclosed technology.

### DETAILED DESCRIPTION

The disclosed technology relates generally to systems and methods for heating water with a tankless water heater having an electric heating element and a gas burner. The electric heating element and the gas burner can be controlled by a controller configured to receive flow data from a flow sensor and determine, based at least in part on the flow data, whether to use the electric heating element or the gas burner to heat the water. For example, the controller can determine to heat the water using the electric heating element at low flows and to heat the water using the gas burner at comparatively higher flows. As will become apparent throughout this disclosure, the disclosed technology can include various methods of controlling the electric heating element and the gas burner to heat the water.

Although certain examples of the disclosed technology are explained in detail herein, it is to be understood that other examples, embodiments, and implementations of the disclosed technology are contemplated. Accordingly, it is not intended that the disclosed technology is limited in its scope to the details of construction and arrangement of components expressly set forth in the following description or illustrated in the drawings. The disclosed technology can be implemented in a variety of examples and can be practiced or carried out in various ways. In particular, the presently disclosed subject matter is described in the context of being a system and method for heating water using a tankless water heater. The present disclosure, however, is not so limited, and can be applicable in other contexts. The present disclosure, for example and not limitation, can include other water heater systems such as boilers, pool heaters, industrial water heaters, and other water heater systems configured to heat flowing water. Furthermore, the present disclosure can include other fluid heating systems configured to heat a fluid other than water such as process fluid heaters used in industrial applications. Such implementations and applications are contemplated within the scope of the present disclosure. Accordingly, when the present disclosure is described in the context of being a system and method for heating water using a tankless water heater, it will be understood that other implementations can take the place of those referred to.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the examples, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the various examples of the disclosed technology includes from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” can be used herein to connote different aspects of methods employed, the term should not be interpreted as implying any particular order among or between various steps herein disclosed unless and except when the order of individual steps is explicitly required. Further, the disclosed technology does not necessarily require all steps included in the example methods and processes described herein. That is, the disclosed technology includes methods that omit one or more steps expressly discussed with respect to the examples provided herein.

The components described hereinafter as making up various elements of the disclosed technology are intended to be illustrative and not restrictive. Many suitable components that would perform the same or similar functions as the components described herein are intended to be embraced within the scope of the disclosed technology. Such other components not described herein can include, but are not limited to, for example, similar components that are developed after development of the presently disclosed subject matter.

Although the term “water” is used throughout this specification, it is to be understood that other fluids may take the place of the term “water” as used herein. Therefore, although described as a tankless water heater system, it is to be understood that the system and methods described herein can apply to fluids other than water. Further, it is also to be understood that the term “water” can replace the term “fluid” as used herein unless the context clearly dictates otherwise.

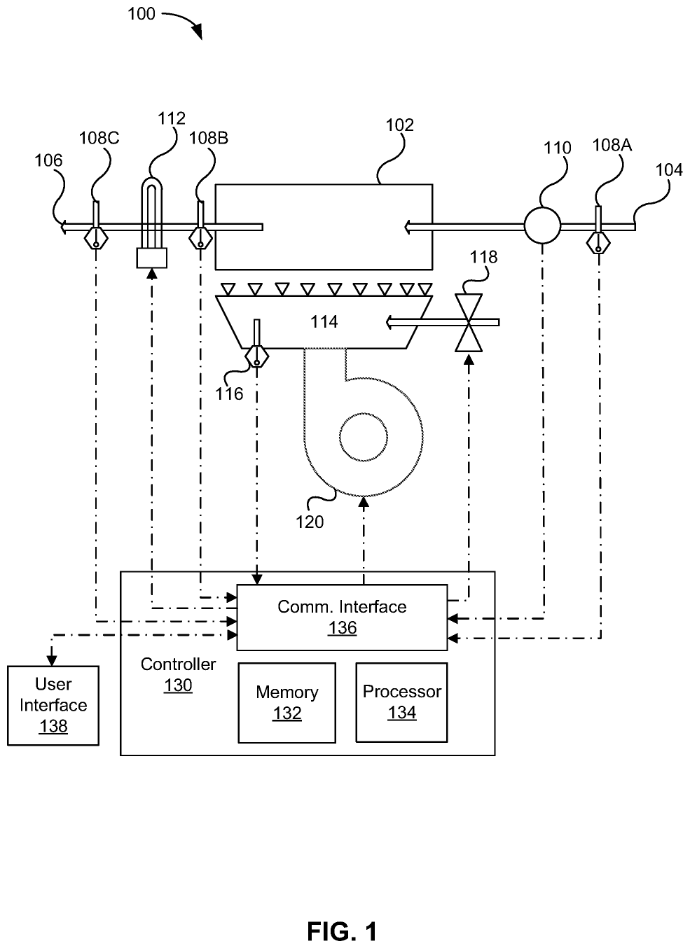

Referring now to the drawings, in which like numerals represent like elements, examples of the present disclosure are herein described. FIG. 1 illustrates an example tankless water heater system 100, in accordance with the disclosed technology. The tankless water heater system 100 can include a low fluid capacity heating chamber 102 having a fluid inlet 104 and a fluid outlet 106. The heating chamber 102 can be configured to receive water or other fluids through the fluid inlet 104 and direct the water toward the fluid outlet 106. An electric heating element 112 and a gas burner 114 can be in communication with a controller 130 and configured to provide heat to the water flowing through the heating chamber 102.

Although commonly referred to as “tankless” water heaters, on-demand water heaters often use some form of small storage tank in which to heat the water. The low fluid capacity heating chamber 102 can be used to help facilitate heating of the water using a gas burner 114 and an electric heating element 112. For example, the gas burner 114 can be configured to consume a mixture of fuel and air and the resultant combustion gases and heat can be directed to a heat exchanger in communication with the low fluid capacity heating chamber 102 or otherwise used to heat the water in the low fluid capacity heating chamber 102 (e.g., the low fluid capacity heating chamber 102 can itself serve as a heat exchanger with combustion gases passing around the exterior of the heating chamber 102). Furthermore, the electric heating element 112 can also be configured to heat the water in the low fluid capacity heating chamber 102. As will be appreciated, although depicted in FIG. 1 as being located downstream of the heating chamber 102, the electric heating element 112 can be located within the heating chamber 102 or downstream of the heating chamber 102 as illustrated.

The heating chamber 102 can be sized for various applications. For example, the heating chamber 102 can have a capacity of fifteen gallons or less for a typical usage application. As another example, the heating chamber 102 can be sized between one and two gallons for use with a bathroom sink in a user's home, as based on the average user's demand for hot water. Depending on the application, the heating chamber 102 can have a capacity of 0.25 gallons, 0.5 gallons, 1 gallon, 1.5 gallons, 2, gallons, 2.5 gallons, 3 gallons, 3.5 gallons, 4 gallons, 4.5 gallons, 5 gallons, or any other suitable size to fit the particular application. For example, the heating chamber 102 can have a capacity of ten gallons, fifteen gallons, or more. The heating chamber 102 can be sized to meet U.S. Department of Energy (DOE) conservation standards for consumer water heaters. For example, the low fluid capacity heating chamber can be less than 2 gallons to meet DOE standards for instantaneous water heaters found in 10 C.F.R. 430.32(d) (effective Mar. 10, 2020).

The heating chamber 102 can be made of any suitable material for storing and heating water, including copper, carbon steel, stainless steel, ceramics, polymers, composites, or any other suitable material. Furthermore, the heating chamber 102 can be treated or lined with a coating to prevent corrosion and leakage. A suitable treating or coating will be capable of withstanding the temperature and pressure of the system and can include, as non-limiting examples, glass enameling, galvanizing, thermosetting resin-bonded lining materials, thermoplastic coating materials, cement coating, or any other suitable treating or coating for the application. Optionally, the heating chamber 102 can be insulated to retain heat. For example, the heating chamber 102 can also be insulated using fiberglass, aluminum foil, organic material, or any other suitable insulation material.

The tankless water heater system 100 can have one or more temperature sensors 108 (shown in FIG. 1 as three sensors 108A, 108B, and 108C) configured to detect a temperature of the water in the system. The temperature sensors 108A, 108B, and 108C can be located or positioned to detect a temperature of the water in the system at various locations such as upstream of the heating chamber 102, inside of the heating chamber 102, downstream of the heating chamber 102, downstream of the electric heating element 112, or any other suitable location in the system 100 where the temperature of the water can be detected. The temperature sensors 108A, 108B, and 108C can each be configured to output temperature data and be in communication with a controller 130. As will be described in greater detail herein, the temperature data provided by the temperature sensors 108A, 108B, and 108C can be used by the controller 130 to determine actions based on current system conditions.

Although three temperature sensors 108A, 108B, and 108C are depicted in FIG. 1, the system 100 can include one, two, four, five, or more temperature sensors, and the number of sensors used can be selected depending on the application or any number of reasons. For example, the system 100 can include only temperature sensor 108A to measure the temperature of the water proximate the fluid inlet 104, or the system 100 can include only temperature sensor 108B to measure the temperature of the fluid exiting the heating chamber 102, or the system 100 can include only temperature sensor 108C to measure the temperature of the water downstream of the electric heating element 112. Alternatively, the system 100 can include two of the three temperature sensors 108A, 108B, and 108C depicted in FIG. 1, all three of the temperature sensors 108A, 108B, and 108C, or the system 100 can include four, five, or more temperature sensors. As will be appreciated, the number of temperature sensors and the location of the temperature sensors can be varied depending on the particular application.

The temperature sensor(s) 108A, 108B, and 108C can be any type of temperature sensor capable of measuring a temperature of a fluid and providing temperature data indicative of the fluid temperature to the controller 130. For example, the temperature sensors 108A, 108B, and 108C can be thermocouples, resistor temperature detectors, thermistors, infrared sensors, semiconductors, or any other type of sensors which would be appropriate for a given use or application. All temperature sensors of the system can be the same type of temperature sensor, or the system 100 can include different types of temperature sensors. For example, temperature sensor 108A can be a thermocouple while temperature sensor 108B can be a thermistor. One skilled in the art will appreciate that the type, location, and number of temperature sensors can vary depending on the application.

The system 100 can include a flow sensor 110 configured to detect a flow of water through the system 100 and output flow data. The flow sensor 110 is shown as being installed just downstream of the fluid inlet 104 but can be installed in alternative locations that are in fluid communication with the heating chamber 102. For example, the flow sensor 110 can be installed just downstream of the fluid inlet 104, inside the heating chamber 102, downstream of the heating chamber 102, or even upstream of the fluid inlet 104 or downstream of the fluid outlet 106 so long as the flow sensor 110 is able to detect a positive flow (fluid flowing through the heating chamber 102 in the direction from the fluid inlet 104 and toward the fluid outlet 106) of a fluid flowing into the heating chamber 102. Regardless of position, the flow sensor 110 can detect the flow rate of the fluid at the location of the flow sensor and can transmit flow data indicative of the flow rate to the controller 130.

The flow sensor 110 can be any type of flow sensor and can be configured to simply detect fluid flow or can be used to detect a rate of flow of the fluid. If it is preferred to simply measure the presence of fluid flow, the flow sensor 110 can be a flow switch. If the flow sensor 110 is a flow switch, it can be a vane actuated flow switch, a disc actuated flow switch, a liquid flow switch, or any other suitable type of flow switch for the application. If it is desirable to measure the rate of fluid flow, the flow sensor 110 can be a flow meter or another type of rate-measuring flow sensor. For example, the flow sensor 110 can be a differential pressure flow meter, a positive displacement flow meter, a velocity flow meter, a mass flow meter, an open channel flow meter, or any other type of flow meter configured to measure flow rate of a fluid. The type of flow sensor 110 used will depend on the type of fluid being measured, its temperature, pressure, viscosity, conductivity, corrosiveness, cleanliness, and other properties of the fluid in the system.

The system 100 can include one or more electric heating elements 112 configured to provide heat to the fluid in the system 100. The electric heating element 112 can be located anywhere in the system 100 where the electric heating element 112 can provide heat to the fluid in the system 100. For example, the electric heating element 112 can be located upstream of the heating chamber 102, inside of the heating chamber 102, or downstream of the heating chamber 102. In systems 100 having more than one heating element 112, as another example, one heating element 112 can be located inside of the heating chamber 102 while one or more other heating element(s) 112 can be located upstream or downstream of the heating chamber 102, or both. If located outside of the heating chamber 102, the electric heating element(s) 112 can be located proximate the heating chamber 102 (i.e., in the same housing as the heating chamber 102, in the same general location as the heating chamber 102 and/or in the same room of a building as the heating chamber 102). The electric heating element(s) 112 can be configured to be controlled by the controller 130 based on a control signal output by the controller 130. The electric heating element 112 can be modulated by the controller 130 to vary the output of the electric heating element 112. For example, the controller 130 can output a control signal to modulate the electric heating element 112 to operate at anywhere between 0% to 100% of the electric heating element's 112 capacity.

The electric heating element 112 can include any form of resistive heating element suitable for the application. For example, the electric heating element 112 can be made with a Nichrome (NiCr) resistive element surrounded by an insulating material and encased in a casing. The resistive element can be made from Nichrome, Kanthal™, Constantan, Manganin™, Balco™ or any other suitable material. The insulating material can be made from insulating material such as Magnesium Oxide, glass, porcelain, composite polymer materials, clay, quarts, alumina, feldspar, or any other suitable insulating material. The casing can be made from a metal (e.g., titanium, stainless steel, nichrome, Kanthal™, cupronickel, etched foil, and the like.), a ceramic (e.g., molybdenum disilicide, silicon carbide, PTC ceramic, and the like.), thick film, or a polymer PTC heating element. Furthermore, the casing can be treated or coated to help prevent corrosion and elongate the life of the element. For example, the system 100 can include an electric heating element 112 with a casing made of copper and treated with a nickel plating. Alternatively or in addition, the electric heating element 112 can include a copper tubing casing coated with magnesium oxide and zinc plating. Alternatively or in addition, the electric heating element 112 can include a titanium or stainless-steel casing that is coated with an appropriate coating, if desired. One of skill in the art will understand that the exact materials and configuration of the electric heating element 112 can vary depending on the particular application.

The system 100 can include a gas burner 114 configured to burn a mixture of fuel and air to create heat that can be used to heat the water. The gas burner 114 can be any type of gas burner capable of burning a mixture of fuel and air to create heat to heat the water. For example and not limitation, the gas burner 114 can be an atmospheric burner, an induced draft burner, a power burner, or any other type of burner suitable for the application. Furthermore, the gas burner 114 can be configured to burn any type of fuel suitable for the application. For example and not limitation, the gas burner 114 can be configured to burn natural gas, propane, butane, coal gas, water gas, methane, biogas, producer gas, syngas, wood gas, blast furnace gas, acetylene, gasoline, or any other suitable type of fuel for the application. The burner 114 can include an igniter configured to ignite the mixture of fuel and air to create a flame at the burner 114.

A flame detector 116 can be used to detect the presence of a flame at the gas burner 114. The flame detector 116 can be configured simply to detect the presence of the flame and output a signal indicating if a flame is present, or the flame detector 116 can be configured to detect a temperature of the flame and output temperature data indicative of a temperature of the flame. The controller 130 can be configured to receive data from the flame detector 116 to determine actions based on the data and other system conditions.

The system 100 can include a fuel valve 118 configured to direct the fuel toward the gas burner 114. The fuel valve 118 can be in communication with the controller 130 such that the controller 130 can be configured to output a control signal to actuate the fuel valve 118 to control the flow of fuel directed toward the gas burner 114. The fuel valve 118, for example and not limitation, can be or include a solenoid operated valve configured to open or close based on a control signal from the controller 130. Furthermore, the fuel valve 118 can be a normally-closed valve such that the fuel valve 118 is capable of preventing the flow of fuel toward the gas burner 114 when the fuel valve 118 is deenergized.

The system 100 can include an air moving device 120 configured to direct a flow of air through the gas burner 114 to help facilitate the combustion of a mixture of fuel and air in the burner 114. The air moving device 120 can be a draft inducer, fan, a blower, or any other air moving device configured to move air through the system 100. Furthermore, the air moving device 120 can be configured to be modulated such that the air moving device 120 can control a velocity of the air being moved through the system 100. The air moving device 120 can also be configured to be controlled by the controller 130.

The controller 130 can have a memory 132, a processor 134, and a communication interface 136. The controller 130 can be a computing device configured to receive data, determine actions based on the received data, and output a control signal instructing one or more components of the system 100 to perform one or more actions. One of skill in the art will appreciate that the controller 130 can be installed in any location, provided the controller 130 is in communication with at least some of the components of the system. Furthermore, the controller 130 can be configured to send and receive wireless or wired signals and the signals can be analog or digital signals. The wireless signals can include Bluetooth™, BLE, WiFi™, ZigBee™, infrared, microwave radio, or any other type of wireless communication as may be suitable for the particular application. The hard-wired signal can include any directly wired connection between the controller and the other components. For example, the controller 130 can have a hard-wired 24 VDC connection to the flow meter 110. Alternatively, the components can be powered directly from a power source and receive control instructions from the controller 130 via a digital connection. The digital connection can include a connection such as an Ethernet or a serial connection and can utilize any suitable communication protocol for the application such as Modbus, fieldbus, PROFIBUS, SafetyBus p, Ethernet/IP, or any other suitable communication protocol for the application. Furthermore, the controller 130 can utilize a combination of wireless, hard-wired, and analog or digital communication signals to communicate with and control the various components. One of skill in the art will appreciate that the above configurations are given merely as non-limiting examples and the actual configuration can vary depending on the particular application.

The controller 130 can include a memory 132 that can store a program and/or instructions associated with the functions and methods described herein and can include one or more processors 134 configured to execute the program and/or instructions. The memory 132 can include one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like) for storing files including the operating system, application programs (including, for example, a web browser application, a widget or gadget engine, and or other applications, as necessary), executable instructions and data. One, some, or all of the processing techniques or methods described herein can be implemented as a combination of executable instructions and data within the memory.

The controller 130 can also have a communication interface 136 for sending and receiving communication signals between the various components. Communication interface 136 can include hardware, firmware, and/or software that allows the processor(s) 134 to communicate with the other components via wired or wireless networks, whether local or wide area, private or public, as known in the art. Communication interface 136 can also provide access to a cellular network, the Internet, a local area network, or another wide-area network as suitable for the particular application.

Additionally, the controller 130 can have or be in communication with a user interface 138 for displaying system information and receiving inputs from a user. The user interface 138 can be installed locally on the system 100 or be a remotely controlled device such as a mobile device. The user, for example, can input data to set one or more threshold flow rates used by the controller 130 to determine actions based on system 100 conditions.

The controller 130 can be configured to determine whether to use the electric heating element 112, the gas burner 114, or both based at least in part on data received from the flow sensor 110 and/or the temperature sensors 108A, 108B, and/or 108C. For example, the controller 130 can receive flow data from the flow sensor 110 and determine, based at least in part on the flow data, whether to output a control signal to operate the electric heating element 112, the gas burner, 114, or both. The controller 130 can be configured to output a control signal to operate the electric heating element 112 when the flow data indicates that the flow rate is less than or equal to a threshold flow rate. If the flow data indicates that the flow rate is greater than the threshold flow rate, the controller 130 can output a control signal to operate the gas burner 114. The threshold flow rate can be a flow rate where, based on system parameters, operating the electric heating element 112 is more efficient for heating water having a flow rate less than or equal to the threshold flow rate while operating the gas burner 114 is more efficient for heating water having a flow rate greater than the threshold flow rate. The threshold flow rate, for example and not limitation, can be 0.25 gallons per minute (GPM), 0.5 GPM, 0.66 GPM, 0.75 GPM, 1 GPM, 1.25 GPM, 1.5 GPM, 1.75 GPM, 2 GPM, 3 GPM, 5 GPM, or any other suitable flow rate for the particular application. Thus, as an example, if the flow data indicates that the current flow rate is less than or equal to 1 GPM, the controller 130 can output a control signal to operate the electric heating element 112. On the other hand, if the flow data indicates that the current flow rate is greater than 1 GPM, the controller 130 can output a control signal to operate the gas burner 114.

Alternatively or additionally, the controller 130 can determine that the electric heating element 112 should be operated if the flow data indicates that the current flow rate is less than or equal to a first threshold flow rate and that the gas burner 114 should be operated if the current flow rate is greater than a second threshold flow rate that is greater than the first threshold flow rate. Alternatively or additionally, the controller 130 can determine that both the electric heating element 112 and the gas burner 114 should be operated when the current flow rate is greater than the first threshold flow rate and less than or equal to the second threshold flow rate. As a non-limiting example, the first threshold flow rate can be 1 GPM while the second threshold flow rate can be 1.2 GPM. As will be appreciated by those of skill in the art, the first threshold flow rate and the second threshold flow rate can be any of the flow rates previously described or any other suitable flow rate based on the particular system such that it is more efficient to operate the electric heating element 112 at flow rates less than or equal to the first threshold flow rate and the gas burner 114 at flow rates greater than the second threshold flow rate.

By operating both the electric heating element 112 and the gas burner 114 at flow rates greater than the first threshold flow rate and less than or equal to the second threshold flow rate, a smooth transition between operation of the two heat sources can be achieved. For example, by operating both the electric heating element 112 and the gas burner 114, the system 100 can ensure there is no significant temperature drop of the water supplied to the point of use during the time between when the electric heating element 112 is turned off and the time when the gas burner 114 is turned on. To accomplish a smooth transition between operation of the electric heating element 112 and the gas burner 114, the electric heating element 112 and/or the gas burner 114 can be modulated to meet the heat load demand until the flow rate is either less than or equal to the first threshold flow rate and only the electric heating element 112 is operated, or the flow rate is greater than the second threshold flow rate and only gas burner 114 is operated.

Alternatively or additionally, the controller 130 can be configured to receive flow data from the flow sensor 110 and temperature data from one or more of temperature sensors 108A, 108B, and/or 108C. Thus, the controller 130 can determine, based at least in part on the flow data and the temperature data, whether to operate the electric heating element 112 or the gas burner 114. For example, if the controller 130 determines that the temperature of the water entering the heating chamber 102 is greater than a threshold temperature but that the flow rate is less than a threshold flow rate, the controller 130 can output a control signal to operate the electric heating element to heat the water. As will be appreciated, the electric heating element 112 can heat the water more efficiently at lower flow rates than the gas burner 114. However, occasionally, a situation may arise where the flow rate is less than the threshold flow rate and the temperature of the water is less than the threshold temperature. In this case, depending on the system, the electric heating element 112 might be unable to heat the water sufficiently and the gas burner 114 can be used to additionally heat the water. This situation could arise, for example, if the temperature of the source water is lower than expected.

Similarly, the controller 130 can be configured to output a control signal to operate the electric heating element 112 when the controller 130 determines, based at least in part on the flow data from the flow sensor 110 and the temperature data from temperature sensors 108A, 108B, and/or 108C, that the flow rate is greater than a threshold flow rate and that the temperature of the water output from the heating chamber is below a threshold temperature. In this situation, the controller 130 can determine to operate the electric heating element 112 as a booster element in addition to the gas burner 114 to help ensure the water delivered to the point of use is at an adequate temperature. This situation could arise, for example, if the flow rate is higher than the burner 114 can adequately heat alone or if the incoming water temperature is so low that the burner 114 is unable to sufficiently heat the water at the given flow rate. As an example, the controller 130 can determine to operate the electric heating element 112 as a booster element in addition to the gas burner 114 if the flow rate is greater than 3 gallons per minute.

As another example, to meet a heat load demand at flow rates less than the threshold flowrate, the controller 130 can output a control signal to modulate the electric heating element 112 to operate at a reduced capacity (e.g., at 25% capacity, 50% capacity, 75% capacity, etc.) to meet the heat load demand. Similarly, to meet the heat load demand at flow rates greater than the threshold flow rate, the controller 130 can output a control signal to modulate the output of the gas burner 114 to meet the varying heat load demand at flow rates greater than the threshold flow rate.

As yet another example, the controller 130 can be configured to output a control signal to operate the electric heating element 112 at flow rates where the gas burner 114 is operating but unable to meet the heat load demand (e.g., at flow rates greater than 3 gallons per minute). For example, the controller 130 can output a control signal to operate the electric heating element 112 when the gas burner 114 is operating at 100% capacity but is unable to meet the heat load demand. In this way, the electric heating element 112 is able to be operated as a booster element to work in tandem with the gas burner 114 to meet the given heat load demand.

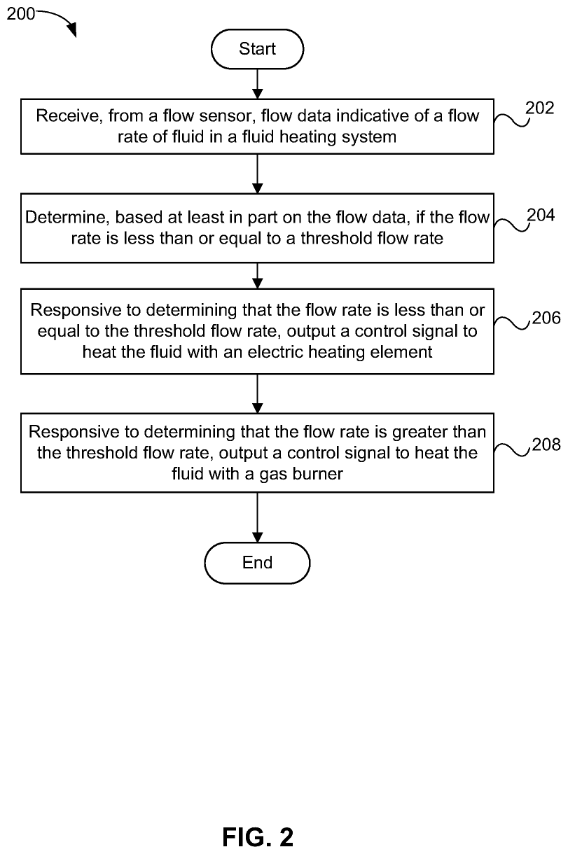

FIG. 2 is a flowchart illustrating an example method 200 of heating water using an electric heating element and a gas burner, in accordance with the disclosed technology. The method 200 can include receiving 202, from a flow sensor, flow data indicative of a flow rate of a fluid in a fluid heating system. The method 200 can include determining 204, based at least in part on the flow data, whether the flow rate is less than or equal to a threshold flow rate. The method 200 can include, responsive to determining that the flow rate is less than or equal to the threshold flow rate, outputting 206 a control signal to heat the fluid with an electric heating element. Furthermore, the method 200 can include, responsive to determining that the flow rate is greater than the threshold flow rate, outputting 208 a control signal to heat the fluid with a gas burner.

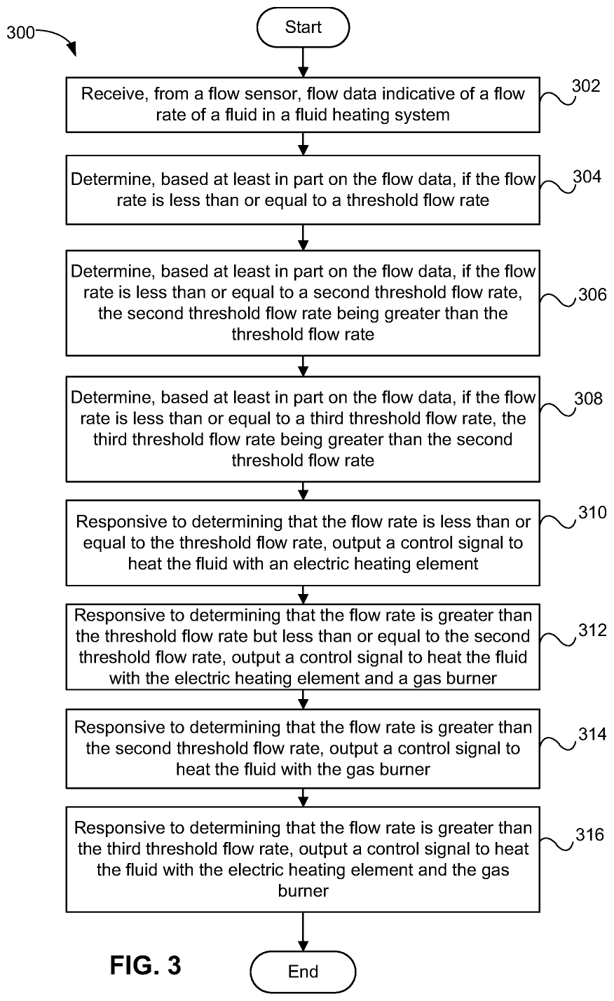

FIG. 3 is a flowchart illustrating another example method 300 of heating water using an electric heating element and a gas burner, in accordance with the disclosed technology. Similar to the method 200, the method 300 can include receiving 302, from a flow sensor, flow data indicative of a flow rate of a fluid in a fluid heating system. The method 300 can also include determining 304, based at least in part on the flow data, whether the flow rate is less than or equal to a first threshold flow rate. The method 300 can include determining 306, based at least in part on the flow data, whether the flow rate is less than or equal to a second threshold flow rate that is greater than the first threshold flow rate. The method can additionally include determining 308, based at least in part on the flow data, whether the flow rate is less than or equal to a third threshold flow rate, the third threshold flow rate being greater than the second threshold flow rate. Responsive to determining that the flow rate is less than or equal to the first threshold flow rate, the method 300 can include outputting 310 a control signal to heat the fluid with an electric heating element. Responsive to determining that the flow rate is greater than the first threshold flow rate and less than the second threshold flow rate, the method 300 can include outputting 312 a control signal to heat the fluid with the electric heating element and a gas burner. Responsive to determining that the flow rate is greater than the second threshold flow rate, the method 300 can include outputting 314 a control signal to heat the fluid with the gas burner. Responsive to determining that the flow rate is greater than the third threshold flow rate, the method 300 can include outputting 316 a control signal to heat the fluid with the electric heating element and the gas burner. As will be appreciated, by outputting 316 a control signal to heat the fluid with the electric heating element and the gas burner, the method 300 can provide additional heat to the water when the gas burner has reached its maximum capacity (e.g., the electric heating element can act as a booster to raise the temperature of the water).

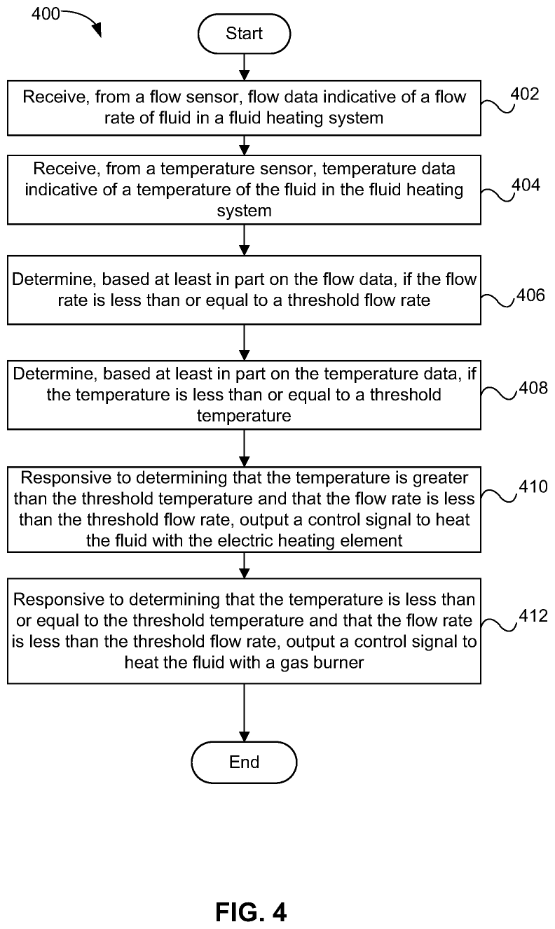

FIG. 4 is a flowchart illustrating yet another example method 400 of heating water using an electric heating element and a gas burner, in accordance with the disclosed technology. The method 400 can include receiving 402, from a flow sensor, flow data indicative of a flow rate of a fluid in a heating system. The method can additionally include receiving 404, from a temperature sensor, temperature data indicative of a temperature of the fluid in the fluid heating system. The method 400 can include determining 406, based at least in part on the flow data, whether the flow rate is less than or equal to a threshold flow rate. The method 400 can include determining 408, based at least in part on the temperature data, whether the temperature is less than or equal to a threshold temperature. Responsive to determining that the temperature is greater than the threshold temperature and that the flow rate is less than the threshold flow rate, the method 400 can include outputting 410 a control signal to heat the fluid with the electric heating element. Responsive to determining that the temperature is less than or equal to the threshold temperature and that the flow rate is less than the threshold flow rate, the method 400 can include outputting 412 a control signal to heat the fluid with a gas burner.

As will be appreciated, the methods 200, 300, and 400 just described can be varied in accordance with the various elements and examples described herein. That is, methods in accordance with the disclosed technology can include all or some of the steps described above and/or can include additional steps not expressly disclosed above. Further, methods in accordance with the disclosed technology can include some, but not all, of a particular step described above. Further still, various methods described herein can be combined in full or in part. That is, methods in accordance with the disclosed technology can include at least some elements or steps of a first method (e.g., method 200) and at least some elements or steps of a second method (e.g., method 300 or 400).

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. But other equivalent methods or compositions to these described aspects are also contemplated by the teachings herein. Therefore, the present disclosure should not be limited to any single aspect, but rather construed in breadth and scope in accordance with the appended claims.

What is claimed is:

1. A non-transitory, computer-readable medium having instructions stored thereon that, when executed by one or more processors, cause a system to:
receive, from a flow sensor, flow data indicative of a flow rate of water in a tankless water heater system;
compare, based at least in part on the flow data, the flow rate to a first threshold flow rate;
compare, based at least in part on the flow rate data, the flow rate to a second threshold flow rate;
responsive to determining that the flow rate is less than or equal to the first threshold flow rate, output a control signal to heat the water with an electric heating element only;
responsive to determining that the flow rate is greater than the second threshold flow rate, output a control signal to heat the water with a gas burner only.

2. The non-transitory, computer-readable medium of claim 1, wherein the second threshold flow rate is equal to the first threshold flow rate.

3. The non-transitory, computer-readable medium of claim 2, wherein:
the second threshold flow rate is greater than the first threshold flow rate; and
the instructions, when executed by the one or more processors, further cause the system to:
responsive to determining that the flow rate is greater than the first threshold flow rate and less than or equal to the second threshold flow rate, output a control signal to heat the water with both the electric heating element and the gas burner.

4. The non-transitory, computer-readable medium of claim 3, wherein the instructions, when executed by the one or more processors, further cause the system to:
compare, based at least in part on the flow data, the flow rate to a third threshold flow rate that is greater than the second threshold flow rate;
responsive to determining that the flow rate is greater than the third threshold flow rate, output a booster-mode control signal to heat the water with both the electric heating element and the gas burner.

5. The non-transitory, computer-readable medium of claim 4, wherein the third threshold flow rate is about 3 gallons per minute.

6. The non-transitory, computer-readable medium of claim 1, wherein the first threshold flow rate is about 1 gallon per minute.

7. The non-transitory, computer-readable medium of claim 1, wherein the first threshold flow rate is about 1.2 gallons per minute.

8. The non-transitory, computer-readable medium of claim 1, wherein the first threshold flow rate is about 1 gallon per minute and the second threshold flow rate is about 1.2 gallons per minute.

9. The non-transitory, computer-readable medium of claim 1, wherein the instructions, when executed by the one or more processors, further cause the system to:
receive, from a temperature sensor, temperature data indicative of a temperature of the water in the tankless water heater system;
compare, based at least in part on the temperature data, the temperature to a threshold temperature; and
responsive to determining that the temperature is greater than the threshold temperature and the flow rate is less than the first threshold flow rate, output a control signal to heat the water with the electric heating element only.

10. The non-transitory, computer-readable medium of claim 9, wherein the instructions, when executed by the one or more processors, further cause the system to:
responsive to determining that the temperature is less than or equal to the threshold temperature and the flow rate is less than the first threshold flow rate, output a control signal to heat the water with both the electric heating element and the gas burner.

11. A fluid heating device comprising:
a fluid inlet;
a fluid outlet;
a heating chamber in fluid communication with the fluid inlet and the fluid outlet, the heating chamber configured to hold a fluid and having a low fluid capacity;
a flow sensor configured to detect a flow of the fluid in the fluid heating device and output flow data indicative of a flow rate of the fluid;
an electric heating element configured to heat the fluid;
a gas burner configured to heat the fluid; and
a controller configured to:
receive the flow data from the flow sensor;
compare, based at least in part on the flow data, the flow rate to a first threshold flow rate;
compare, based at least in part on the flow rate data, the flow rate to a second threshold flow rate;
responsive to determining that the flow rate is less than or equal to the first threshold flow rate, output a control signal to heat the fluid with an electric heating element only;
responsive to determining that the flow rate is greater than the second threshold flow rate, output a control signal to heat the fluid with a gas burner only.

12. The fluid heating device of claim 11, wherein the second threshold flow rate is equal to the first threshold flow rate.

13. The fluid heating device of claim 11, wherein the first threshold flow rate is about 1 gallon per minute.

14. The fluid heating device of claim 11, wherein the first threshold flow rate is about 1.2 gallons per minute.

15. The fluid heating device of claim 11, wherein:
the second threshold flow rate is greater than the first threshold flow rate; and
the controller is further configured to:
responsive to determining that the flow rate is greater than the first threshold flow rate and less than or equal to the second threshold flow rate, output a control signal to heat the fluid with both the electric heating element and the gas burner.

16. The fluid heating device of claim 15, wherein the first threshold flow rate is about 1 gallon per minute and the second threshold flow rate is about 1.2 gallons per minute.

17. The fluid heating device of claim 11, wherein the controller is further configured to:
compare, based at least in part on the flow data, the flow rate to a third threshold flow rate that is greater than the second threshold flow rate;
responsive to determining that the flow rate is greater than the third threshold flow rate, output a booster-mode control signal to heat the fluid with both the electric heating element and the gas burner.

18. The fluid heating device of claim 17, wherein the third threshold flow rate is about 3 gallons per minute.

19. The fluid heating device of claim 11, further comprising a temperature sensor configured to detect a temperature of the fluid in the fluid heating device and output temperature data indicative of the temperature of the fluid,
wherein the controller is further configured to:
receive the temperature data from the temperature sensor;
compare, based at least in part on the temperature data, the temperature to a threshold temperature; and
responsive to determining that the temperature is greater than the threshold temperature and the flow rate is less than the first threshold flow rate, output a control signal to heat the fluid with the electric heating element only.

20. The fluid heating device of claim 19, wherein the controller is further configured to:
responsive to determining that the temperature is less than or equal to the threshold temperature and the flow rate is less than the first threshold flow rate, output a control signal to heat the fluid with both the electric heating element and the gas burner.
